(19) United States
(12) Patent Application Publication
(10) Pub. No.: US 2022/0321380 A1
(43) Pub. Date: Oct. 6, 2022

(54) DATA PROCESSING METHOD BASED ON NETWORK SLICES AND APPARATUS THEREFOR

(71) Applicant: ZTE CORPORATION, Shenzhen, Guangdong (CN)

(72) Inventor: Kui ZHANG, Shenzhen, Guangdong (CN)

(21) Appl. No.: 17/613,944

(22) PCT Filed: May 6, 2020
(86) PCT No.: PCT/CN2020/088758

§ 371 Date: Nov. 23, 2021

(30) Foreign Application Priority Data
Jun. 28, 2019 (CN) 201910580239.3

(51) Int. Cl. H04L 12/46; H04L 45/74; H04L 61/2596; H04L 45/00

(52) U.S. Cl. CPC H04L 12/4675; H04L 45/74; H04L 61/2596; H04L 45/66

(57) ABSTRACT

A data processing method based on network slices comprises determining on a data plane a network slice to which a data flow belongs according to network slice resource information, an uplink port receiving the data flow, virtual local area network (VLAN) information carried by the data flow, and destination media access control (MAC) address of the data flow. The method further comprises processing and forwarding the data flow through the network slice to which the data flow belongs. In the network slice resource information, different network slices sharing a VLAN on a shared uplink port are configured with different three-layer interface MAC addresses.

### CROSS REFERENCE TO RELATED APPLICATIONS

The present application claims priority to Chinese patent application No. 201910580239.3, filed Jun. 28, 2019, which is incorporated by reference herein in its entirety.

### TECHNICAL FIELD

The embodiments of the present disclosure relate to, but are not limited to, the field of access network communication technology, in particular to a data processing method based on network slices and an apparatus therefor.

### BACKGROUND

With the development of virtualization technology, network slice technology may encounter some restrictions that affect service provisioning in the application and popularization of access devices.

When network slices are deployed on an existing network, the number of uplink ports or uplink lines of an access node may be insufficient so that it is impossible to allocate an independent uplink channel for each network slice. Therefore, it is desired that multiple network slices share one or a group of uplink ports. In an exclusive mode of the port, the port may only serve one certain network slice, and the data flow sent and received by the port belongs to the network slice where the port is located. In a sharing mode of the port, the port is shared by multiple network slices. Unlike the exclusive mode, it is impossible in the sharing mode to directly determine the network slice to which the service data flow belongs according to the port. Therefore, it is necessary to assign a virtual local area network (VLAN) available on the shared port for each of the network slices. Then, when the shared port receives a data message, the network slice to which the data flow belongs may be identified according to outer VLAN information of the data message, and the data flow may continue to be forwarded in the identified network slice. In other words, in the sharing mode of the port, different network slices are unable to use the same VLAN on the shared port.

However, before the network slice is enabled, a user put all physical network elements under a unified VLAN for management, while network slice technology generates multiple virtualized logical devices on one physical device. Therefore, the user may expect the physical device to be consistent in management with the logical devices, that is, all devices may be managed using the same VLAN.

It can be seen that the network slices sharing the uplink channel require not to use the same VLAN on the shared uplink port, but the user requires to use the same VLAN to manage all physical and logical network elements. These two requirements are conflicting. The flexibility of networking and even network planning for the user will be affected if these two requirements are unable to be met at the same time.

### SUMMARY

The present disclosure provides a data processing method based on network slices and an apparatus therefor.

In one aspect, the present disclosure provides data processing method based on network slices. The method includes: determining on a data plane a network slice to which a data flow belongs according to network slice resource information, an uplink port receiving the data flow, virtual local area network (VLAN) information carried by the data flow, and a destination media access control (MAC) address of the data flow; processing and forwarding the data flow through the network slice to which the data flow belongs. Herein, different network slices sharing a VLAN on a shared uplink port are configured with different three-layer interface MAC addresses in the network slice resource information.

In another aspect, the present disclosure provides a data processing apparatus based on network slices, including a forwarding plane network slice identification unit and a plurality of network slice forwarding plane processing units. The forwarding plane network slice identification unit is configured to determine on a data plane a network slice to which a data flow belongs according to network slice resource information, an uplink port receiving the data flow, VLAN information carried by the data flow, and the destination MAC address of the data flow. One of the plurality of network slice forwarding plane processing units corresponding to the network slice to which the data flow belongs is configured to process and forward the data flow. Herein, different network slices sharing a VLAN on a shared uplink port are configured with different three-layer interface MAC addresses in the network slice resource information.

In still another aspect, the present disclosure also provides a computer-readable storage medium storing a computer program that, when executed, causes a processor to perform the aforementioned data processing method.

Other features and advantages of the present disclosure will be described in the following specification, and partly become obvious from the specification, or understood by implementing the present disclosure. The purpose and other advantages of the present disclosure may be realized and obtained through a structure specifically pointed out in the specification, claims and drawings.

### BRIEF DESCRIPTION OF THE DRAWINGS

The accompanying drawings are used to provide a further understanding of the technical solution of the present disclosure, and constitute a part of the specification. Together with the embodiments of the present disclosure, the accompanying drawings are used to explain the technical solution of the present disclosure, and do not constitute a limitation to the technical solution of the present disclosure.

FIG. 1 is a schematic diagram of a data processing apparatus based on network slices according to an embodiment of the present disclosure.

FIG. 2 is a schematic diagram of collaboration among units when an uplink port is in a non-sharing mode.

FIG. 3 is a flowchart of a data processing method based on network slices according to an embodiment of the present disclosure.

### DETAILED DESCRIPTION

In order to make the purpose, the technical solution, and the advantages of the present disclosure clearer, embodiments of the present disclosure will be described in detail below with reference to the accompanying drawings. It should be noted that the embodiments in the present disclosure and the features in the embodiments may be combined with each other arbitrarily in a condition without conflict.

The steps shown in the flowchart of the accompanying drawings may be performed in a computer system storing a set of computer-executable instructions. And, although a logical sequence is shown in the flowchart, in some cases, the steps shown or described may be performed in an order other than that described herein.

Embodiments of the present disclosure provide a data processing method based on network slices and an apparatus therefor, applicable to an access node employing a network slice technology. The method and apparatus provided in the embodiments of the present disclosure can effectively support the network slices to use a same virtual local area network (VLAN) on an uplink port shared by the network slices.

Embodiments of the present disclosure provide a data processing apparatus based on network slices, including: a forwarding plane network slice identification unit and a plurality of network slice forwarding plane processing units. Herein, the forwarding plane network slice identification unit is configured to determine on a data plane a network slice to which a data flow belongs according to network slice resource information, an uplink port receiving the data flow, VLAN information carried by the data flow, and a destination media access control (MAC) address of the data flow. One of the plurality of network slice forwarding plane processing unit corresponding to the network slice to which the data flow belongs is configured to process and forward the data flow. Herein, different network slices sharing a VLAN on a shared uplink port are configured with different three-layer interface MAC addresses in the network slice resource information.

Herein, the access node may include a control plane and a data plane. The control plane is responsible for processing of local protocol and management and maintenance of forwarding information database, including generating, managing and maintaining the forwarding information database required by the data plane. The data plane is responsible for processing and forwarding of a service data flow according to the forwarding information database issued by the control plane.

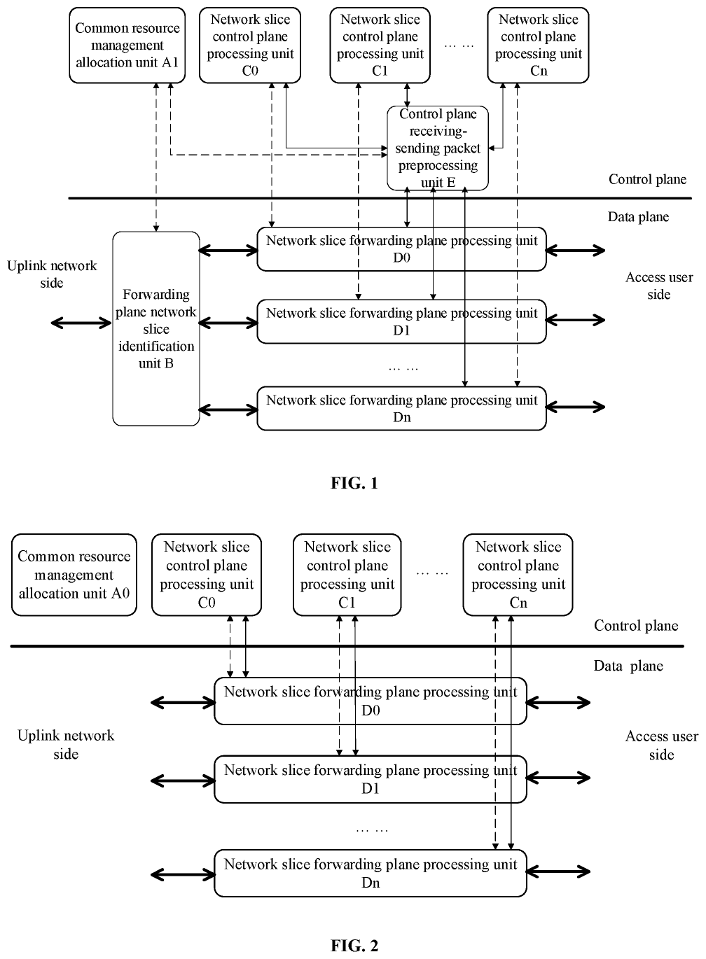

FIG. 1 is a schematic diagram of a data processing apparatus based on network slices according to an embodiment of the present disclosure. As shown in FIG. 1, the apparatus provided in this embodiment is applicable to an access node, including: a common resource management and allocation unit A1, a forwarding plane network slice identification unit B, a plurality of network slice forwarding plane processing units D0 to Dn, a control plane sending-receiving packet preprocessing unit E and a plurality of network slice control plane processing units C0 to Cn. Herein, the forwarding plane network slice identification unit B is located on a receiving side of an uplink network. In FIG. 1, thick black lines with arrows indicate service data flow transmission, thin black lines indicate protocol packet transmission, and dashed lines indicate control flow transmission.

It should be noted that, since the embodiment of the present disclosure does not involve an control plane protocol processing and a forwarding plane data forwarding processing intrinsically inside the network slice, the processing of any network slice may be simplified as the following two parts in FIG. 1: the network slice control plane processing unit and the network slice forwarding plane processing unit. Herein, the network slice control plane processing unit Cn represents a control plane processing unit of a network slice numbered n, and the network slice forwarding plane processing unit Dn represents a forwarding plane processing unit of the network slice numbered n, where n may be a positive integer.

In this exemplary embodiment, the common resource management and allocation unit A1 is responsible for the management and allocation of resources (for example, ports, VLANs available for ports, etc.), and may, through command configuration, allocate resources to any network slice, or retrieve resources from any network slice.

In this exemplary embodiment, the common resource management and allocation unit A1 may allocate resources to any network slice through the command configuration, and send the network slice resource information to the forwarding plane network slice identification unit B and the control plane sending-receiving packet preprocessing unit E. In an example, the network slice resource information may include: information of the network slice to which the uplink port belongs, information (for example, VLAN identification) of the VLAN used on the shared uplink port by different network slices, information of the VLAN shared by different network slices, and the three-layer interface MAC addresses corresponding to different network slices that share the VLAN on the shared uplink port.

In this exemplary embodiment, the forwarding plane network slice identification unit B may, when receiving the service data flow, determine the network slice to which the service data flow belongs according to the network slice resource information sent by the common resource management and allocation unit A1. The network slice forwarding plane processing unit Dn may process and forward the service data flow belonging to the corresponding network slice n, and the network slice forwarding plane processing unit Dn may upload a three-layer protocol packet that needs to be processed by the control plane of the access node to the control plane sending-receiving packet preprocessing unit E. The control plane sending-receiving packet preprocessing unit E may identify protocol packets received on the VLAN shared by multiple network slices on the shared uplink port, and copy broadcast or multicast protocol packets among the protocol packets to the network slice control plane processing units corresponding to the network slices sharing the uplink port and the VLAN (for example, the network slice control plane processing unit Cn corresponding to the network slice n). In this way, the same VLAN may be used to run three-layer service on a shared uplink port of multiple network slices, thus meeting the requirement that the shared uplink port of multiple network slices uses the same VLAN to manage network elements.

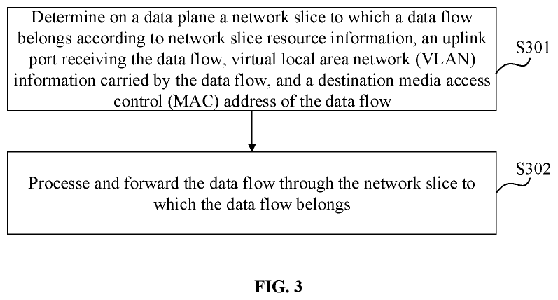

FIG. 2 is a schematic diagram of collaboration among units when the uplink port is in a non-sharing mode. As shown in FIG. 2, the access node may include: a common resource management and allocation unit A0, the network slice control plane processing units C0 to Cn, and the network slice forwarding plane processing units D0 to Dn. In FIG. 2, thick black lines with arrows indicate the service data flow transmission, thin black lines indicate the protocol packet transmission, and dashed lines indicate the control flow transmission. The related description for the network slice control plane processing units and the network slice forwarding plane processing units may refer to the description with respect to FIG. 1, which will not be repeated here. As shown in FIG. 2, when the uplink port is not shared (that is, one uplink port may only belong to one certain network slice), with clear resource attribution, the service data flow is directly processed on the network slice forwarding plane processing unit corresponding to the network slice to which the uplink port belongs, and the protocol packet is processed on the network slice control plane processing unit corresponding to the network slice to which the uplink port belongs.

Compared with FIG. 2, in the access node shown in FIG. 1, with the additional forwarding plane network slice identification unit B on the data plane and the additional control plane sending-receiving packet preprocessing unit E on the control plane for supporting corresponding processing, it is thus supported that multiple network slices share the uplink port and the VLAN.

The data processing method based on the network slice provided in an embodiment of the present disclosure will be exemplarily described with reference to FIG. 1. The method provided by this exemplary embodiment includes the following processing.

In a first step, the common resource management and allocation unit A1 allocates resources to each network slice through the command configuration, including allocating uplink ports in an exclusive or a shared manner, and assigning the VLANs available on the shared uplink port for different network slices. In this step, different network slices have different VLANs available on the shared uplink port.

In a second step, the common resource management and allocation unit A1 assign, through the command configuration, a VLAN to be shared by different network slices on the shared uplink port. It should be noted that the VLAN assigned to be shared needs to be allocated to one certain network slice in the first step, other network slices may also use the VLAN on the shared port. In the following, the network slice to which the VLAN belongs is the network slice to which the VLAN is allocated in the first step.

In a third step, the common resource management and allocation unit A1 performs an intra-slice service configuration for each network slice, which may include configuring the three-layer interface MAC address for the VLAN shared on the shared uplink port. It should be noted that the three-layer interface MAC addresses on the shared uplink port for different network slices are different. In this way, in the case that the network slices use the same VLAN on the shared port, the network slices may be identified by the three-layer interface MAC addresses.

In a fourth step, the common resource management and allocation unit A1 sends port ownership information, the VLANs available on the shared uplink port for different network slices, the VLAN shared by different network slices, and the three-layer interface MAC addresses corresponding to the VLAN shared by different network slices (corresponding to the above-mentioned network slice resource information) to the forwarding plane network slice identification logic unit B and the control plane sending-receiving packet preprocessing unit E. Herein, the port ownership information may indicate the network slice to which the uplink port belongs.

In a fifth step, when the uplink port receives the service data flow, the forwarding plane network slice identification unit B performs analysis to determine the network slice to which the service data flow belongs. Herein, the forwarding plane network slice identification unit B first analyzes a situation of the network slice to which the uplink port belongs. If the uplink port is exclusive to one certain network slice, the forwarding plane network slice identification unit B directly determines the network slice to which the service data flow belongs (for example, network slice n) according to the uplink port ownership information, and send the service data flow to the network slice forwarding plane processing unit (for example, the network slice forwarding plane processing unit Dn) corresponding to the determined network slice for continuing processing. If the uplink port is shared by multiple network slices, the next step is performed.

In a sixth step, when the uplink port is shared by multiple network slices, the forwarding plane network slice identification unit B may extract outer VLAN information of a data packet of the service data flow, and analyzes the ownership of the VLAN indicated by the outer VLAN information. If the VLAN is exclusive to a certain network slice, that is, the VLAN only belongs to the certain network slice, the forwarding plane network slice identification unit B may determine the network slice to which the service data flow belongs according to the ownership of the VLAN, and send the service data flow to the network slice forwarding plane processing unit corresponding to the determined network slice for continuing processing. Otherwise, if the VLAN is shared by multiple network slices, the next step is performed.

In a seventh step, if the VLAN is shared by multiple network slices, the forwarding plane network slice identification unit B may first record the network slice to which the VLAN belongs. Herein, the forwarding plane network slice identification unit B may determine the network slice to which the VLAN is assigned according to the allocation information in the first step, and record the network slice as the network slice to which the VLAN belongs. It should be noted that in the first step, the VLAN on the shared uplink port is only assigned to one network slice.

In this step, the forwarding plane network slice identification unit B may extract the destination MAC address of a service flow data packet, and then search for a matching entry in the network slice resource information according to the VLAN information carried in the service data packet and the extracted destination MAC address, that is, to determine whether there is network slice information (for example, the serial number of the network slice) corresponding to the VLAN information and the destination MAC address. If there is no matching entry, that is, no corresponding network slice is matched according to the VLAN information and the destination MAC address, the forwarding plane network slice identification unit B determines the recorded network slice to which the VLAN belongs as the network slice to which the service data flow belongs, and send the service data flow to the network slice forwarding plane processing unit corresponding to the determined network slice for continuing processing. If there is a matching entry, the next step is performed.

In an eighth step, when determining a network slice matching the VLAN information and MAC address, the forwarding plane network slice identification unit B determines the matched network slice as the network slice to which the service data flow belongs, and sends the service data flow to the network slice forwarding plane processing unit corresponding to the determined network slice for continuing processing.

In a ninth step, the network slice forwarding plane processing unit corresponding to the determined network slice processes and forwards the received service data flow. For two-layer service, the network slice forwarding plane processing unit may directly forward the service data flow.

In this exemplary embodiment, when the three-layer service is enabled, the network slice forwarding plane processing unit may upload the three-layer protocol packet that needs to be processed by the control plane to the control plane sending-receiving packet preprocessing unit E.

In a tenth step, after receiving the protocol packet from the data plane, the control plane sending-receiving packet preprocessing unit E first checks the uplink port receiving the protocol packet and the VLAN information carried in the protocol packet. For the VLAN on the shared uplink port shared by multiple network slices, the control plane sending-receiving packet preprocessing unit E searches for a list of network slices that share the uplink port and the VLAN.

In this step, since the common resource management and allocation unit A1 also sends the network slice resource information to the control plane sending-receiving packet preprocessing unit E, the control plane sending-receiving packet preprocessing unit E may determine, according to the network slice resource information, whether the uplink port receiving the protocol packet and the VLAN indicated by the VLAN information carried in the protocol packet are shared by multiple network slices.

In an eleventh step, the control plane sending-receiving packet preprocessing unit E extracts a destination address of the protocol packet. If the destination address of the protocol packet is a broadcast or multicast (such as ARP (Address Resolution Protocol) packet, routing protocol packet) address, the control plane sending-receiving packet preprocessing unit E copies the protocol packet and sends the protocol packet to all network slice control plane processing units corresponding to the network slices sharing the uplink port and the VLAN. If the destination address of the protocol packet is a unicast address, the protocol packet is only sent to the network slice control plane processing unit corresponding to the network slice to which the VLAN belongs. Herein, the network slice control plane processing unit that receives the protocol packet may continue subsequent processing process for the protocol packet.

The embodiments of the present disclosure support different network slices to be managed by using the same VLAN when the network slices share the uplink port. In this way, requirements for multiple network slices sharing the VLAN to run three-layer service are met, which saves bandwidth overhead to the greatest extent, and improves processing efficiency.

FIG. 3 is a flowchart of a data processing method based on network slices according to an embodiment of the present disclosure. As shown in FIG. 3, the method provided in this embodiment includes the following steps.

In step S301, a network slice to which a data flow belongs is determined on a data plane according to network slice resource information, an uplink port receiving the data flow, VLAN information carried by the data flow, and a destination MAC address of the data flow.

In step S302, the data flow is processed and forwarded through the network slice to which the data flow belongs.

Herein, different network slices sharing a VLAN on a shared uplink port are configured with different three-layer interface MAC addresses in the network slice resource information.

In an exemplary embodiment, step S301 may include steps as follows. A network slice to which the uplink port receiving the data flow belongs is determined according to the network slice resource information. When the uplink port is shared by at least two network slices, the VLAN information is extracted from the data flow, and whether a VLAN indicated by the VLAN information is shared by at least two network slices is determined according to the network slice resource information. When the VLAN is shared by at least two network slices, the destination MAC address is extracted from the data flow, and the network slice to which the data flow belongs is determined according to the network slice resource information, the VLAN information, and the destination MAC address.

In this exemplary embodiment, step S301 may further include: when the uplink port is exclusive to one network slice, it is determined that the data flow belongs to the network slice which the uplink port is exclusive to.

In this exemplary embodiment, step S301 may further include: when the VLAN indicated by the VLAN information carried by the data flow belongs to only one network slice, it is determined that the data flow belongs to the network slice to which the VLAN belongs.

In this exemplary embodiment, the step that when the VLAN is shared by at least two network slices, the destination MAC address is extracted from the data flow, and the network slice to which the data flow belongs is determined according to the network slice resource information, the VLAN information, and the destination MAC address, may include the steps as follows. When the VLAN is shared by at least two network slices, one network slice to which the VLAN belongs is recorded, and the destination MAC address is extracted from the data flow. When a network slice corresponding to the VLAN information and the destination MAC address is matched in the network slice resource information, it is determined that the data flow belongs to the matched network slice. When no network slice corresponding to the VLAN and the destination MAC address is matched in the network slice resource information, it is determined that the data flow belongs to the recorded network slice to which the VLAN belongs. Herein, in a configuration process, on the shared uplink port, different VLANs are assigned (or allocated) to different network slices, and a VLAN is assigned to be shared by at least two network slices (that is, one VLAN is first allocated to one network slice, and then the VLAN is assigned to be shared so that other network slices may also use the VLAN on the shared port). Therefore, on the shared uplink port, the network slice to which the VLAN belongs is the network slice assigned to the VLAN, and whether the VLAN is shared by at least two network slices may be determined according to whether the VLAN is assigned to be shared.

In an exemplary embodiment, the method of this embodiment may further include the steps as follows. When three-layer service is enabled, a list of network slices that share an uplink port and a VLAN indicated by the VLAN information is determined on a control plane according to the network slice resource information, the uplink port corresponding to a protocol packet from the data plane and the VLAN information carried by the protocol packet. When the protocol packet is a broadcast or multicast protocol packet, the protocol packet is copied, and the protocol packet is processed through the network slices listed in the list of network slices. The broadcast or multicast protocol packets are copied and sent on the control plane, which can save bandwidth overhead and improve processing efficiency.

In this exemplary embodiment, the method of this embodiment may further include: when the protocol packet is a unicast protocol packet, the protocol packet is processed through a network slice to which the VLAN indicated by the VLAN information carried in the protocol packet belongs. Herein, the network slice to which the VLAN belongs is the network slice assigned to the VLAN.

In an exemplary embodiment, the network slice resource information may include: information of the network slice to which the uplink port belongs, information of the VLAN used on the shared uplink port by different network slices, information of the VLAN shared by different network slices, and the three-layer interface MAC addresses corresponding to different network slices that share the VLAN on the shared uplink port.

The relevant description of the method provided in this embodiment may refer to the relevant description of the foregoing embodiments with respect to the apparatus, which will not be repeated here.

In summary, the method according to the embodiments of the present disclosure can support the network slices sharing an uplink port to use the same VLAN to manage network elements, and thus achieve the effect that different network slice sharing the uplink port uses the same VLAN to run three-layer service, which saves bandwidth overhead to the greatest extent and improves processing efficiency.

In addition, embodiments of the present disclosure also provide a computer-readable storage medium storing a computer program that, when executed, causes a processor to perform the steps of the data processing method as described above, for example, the steps shown in FIG. 3.

A person of ordinary skill in the art can understand that all or some of the steps, system, functional modules/units of the device in the methods disclosed above may be implemented as software, firmware, hardware, and appropriate combinations thereof. In a hardware implementation, the division between functional modules/units mentioned in the above description does not necessarily correspond to the division of physical components. For example, a physical component may have multiple functions, or a function or step may be performed by several physical components cooperatively. Some or all of the components may be implemented as software executed by a processor, such as a digital signal processor or a microprocessor, or as hardware, or as an integrated circuit, such as an application specific integrated circuit. Such software may be distributed on a computer-readable medium, and the computer-readable medium may include a computer storage medium (or a non-transitory medium) and a communication medium (or a transitory medium). As is well known to those of ordinary skill in the art, the term computer storage medium includes volatile and non-volatile, removable and non-removable medium implemented in any method or technology for storing information (such as computer-readable instructions, data structures, program modules, or other data). Computer storage medium include but are not limited to a random access memory (RAM), a read-only memory (ROM), an electrically erasable programmable read-only memory (EEPROM), a flash memory or other memory technologies, a compact disc read-only memory (CD-ROM), a digital video disc (DVD) or other optical disk storage, a magnetic cassette, a magnetic tape, a magnetic disk storage or other magnetic storage devices, or any other medium used to store desired information and that may be accessed by a computer. In addition, as well known to those of ordinary skill in the art, communication medium usually contain a computer-readable instruction, a data structure, a program module, or other data in a modulated data signal such as a carrier wave or other transmission mechanisms, and may include any information delivery medium.

1. A data processing method based on network slices, comprising:
determining on a data plane a network slice to which a data flow belongs according to network slice resource information, an uplink port receiving the data flow, virtual local area network (VLAN) information carried by the data flow, and a destination media access control (MAC) address of the data flow;
processing and forwarding the data flow through the network slice to which the data flow belongs; and
wherein different network slices sharing a VLAN on a shared uplink port are configured with different three-layer interface MAC addresses in the network slice resource information.

2. The method according to claim 1, wherein determining on the data plane the network slice to which the data flow belongs according to the network slice resource information, the uplink port receiving the data flow, the VLAN information carried by the data flow, and the destination MAC address of the data flow, comprises:
determining a network slice to which the uplink port receiving the data flow belongs according to the network slice resource information;
in response to the uplink port being shared by at least two network slices, extracting the VLAN information from the data flow, and determining whether a VLAN indicated by the VLAN information is shared by at least two network slices according to the network slice resource information; and
in response to the VLAN being shared by at least two network slices, extracting the destination MAC address from the data flow, and determining the network slice to which the data flow belongs according to the network slice resource information, the VLAN information, and the destination MAC address.

3. The method according to claim 2, wherein determining on the data plane the network slice to which the data flow belongs according to the network slice resource information, the uplink port receiving the data flow, the VLAN information carried by the data flow, and the destination MAC address of the data flow, further comprises:
in response to the uplink port being exclusive to one network slice, determining that the data flow belongs to the network slice which the uplink port is exclusive to.

4. The method according to claim 2, wherein determining on the data plane the network slice to which the data flow belongs according to the network slice resource information, the uplink port receiving the data flow, the VLAN information carried by the data flow, and the destination MAC address of the data flow, further comprises:
in response to the VLAN indicated by the VLAN information belonging to only one network slice, determining that the data flow belongs to the network slice to which the VLAN belongs.

5. The method according to claim 2, wherein in response to the VLAN being shared by at least two network slices, extracting the destination MAC address from the data flow, and determining the network slice to which the data flow belongs according to the network slice resource information, the VLAN information, and the destination MAC address, comprises:
in response to the VLAN being shared by at least two network slices, recording one network slice to which the VLAN belongs, and extracting the destination MAC address from the data flow;
in response to matching a network slice corresponding to the VLAN information and the destination MAC address in the network slice resource information, determining that the data flow belongs to the matched network slice; and
in response to matching no network slice corresponding to the VLAN and the destination MAC address in the network slice resource information, determining that the data flow belongs to the recorded network slice to which the VLAN belongs.

6. The method according to claim 1, further comprising:
in response to three-layer service being enabled, determining on a control plane a list of network slices that share an uplink port and a VLAN indicated by VLAN information according to the network slice resource information, the uplink port corresponding to a protocol packet from the data plane and the VLAN information carried by the protocol packet; and
in response to the protocol packet being a broadcast or multicast protocol packet, copying the protocol packet, and processing the protocol packet through the network slices listed in the list of network slices.

7. The method according to claim 6, further comprising:
in response to the protocol packet being a unicast protocol packet, processing the protocol packet through a network slice to which the VLAN indicated by the VLAN information carried in the protocol packet belongs.

8. The method according to claim 1, wherein the network slice resource information comprises: information of the network slice to which the uplink port belongs, and information of the VLAN used on the shared uplink port by different network slices, information of the VLAN shared by different network slices, and the three-layer interface MAC addresses corresponding to different network slices that share the VLAN on the shared uplink port.

9. (canceled)

10. A computer-readable storage medium storing a computer program that, when executed, causes a processor to perform a data processing method; wherein the method comprises:
determining on a data plane a network slice to which a data flow belongs according to network slice resource information, an uplink port receiving the data flow, virtual local area network (VLAN) information carried by the data flow, and a destination media access control (MAC) address of the data flow; and
processing and forwarding the data flow through the network slice to which the data flow belongs;
wherein different network slices sharing a VLAN on a shared uplink port are configured with different three-layer interface MAC addresses in the network slice resource information.

11. A data processing apparatus based on network slices, comprising:
a processor; and
a memory storing a computer program that, when executed, causes the processor to perform a data processing method; wherein the method comprises:
determining on a data plane a network slice to which a data flow belongs according to network slice resource information, an uplink port receiving the data flow, virtual local area network (VLAN) information carried by the data flow, and a destination media access control (MAC) address of the data flow; and
processing and forwarding the data flow through the network slice to which the data flow belongs;
wherein different network slices sharing a VLAN on a shared uplink port are configured with different three-layer interface MAC addresses in the network slice resource information.

12. The apparatus according to claim 11, wherein determining on the data plane the network slice to which the data flow belongs according to the network slice resource information, the uplink port receiving the data flow, the VLAN information carried by the data flow, and the destination MAC address of the data flow, comprises:
determining a network slice to which the uplink port receiving the data flow belongs according to the network slice resource information; and
in response to the uplink port being shared by at least two network slices, extracting the VLAN information from the data flow, and determining whether a VLAN indicated by the VLAN information is shared by at least two network slices according to the network slice resource information;
in response to the VLAN being shared by at least two network slices, extracting the destination MAC address from the data flow, and determining the network slice to which the data flow belongs according to the network slice resource information, the VLAN information, and the destination MAC address.

13. The apparatus according to claim 12, wherein determining on the data plane the network slice to which the data flow belongs according to the network slice resource information, the uplink port receiving the data flow, the VLAN information carried by the data flow, and the destination MAC address of the data flow, further comprises:
in response to the uplink port being exclusive to one network slice, determining that the data flow belongs to the network slice which the uplink port is exclusive to.

14. The apparatus according to claim 12, wherein determining on the data plane the network slice to which the data flow belongs according to the network slice resource information, the uplink port receiving the data flow, the VLAN information carried by the data flow, and the destination MAC address of the data flow, further comprises:
in response to the VLAN indicated by the VLAN information belonging to only one network slice, determining that the data flow belongs to the network slice to which the VLAN belongs.

15. The apparatus according to claim 14, wherein in response to the VLAN being shared by at least two network slices, extracting the destination MAC address from the data flow, and determining the network slice to which the data flow belongs according to the network slice resource information, the VLAN information, and the destination MAC address, comprises:
in response to the VLAN being shared by at least two network slices, recording one network slice to which the VLAN belongs, and extracting the destination MAC address from the data flow;
in response to matching a network slice corresponding to the VLAN information and the destination MAC address in the network slice resource information, determining that the data flow belongs to the matched network slice;
in response to matching no network slice corresponding to the VLAN and the destination MAC address in the network slice resource information, determining that the data flow belongs to the recorded network slice to which the VLAN belongs.

16. The apparatus according to claim 11, wherein the method further comprises:
in response to three-layer service being enabled, determining on a control plane a list of network slices that share an uplink port and a VLAN indicated by VLAN information according to the network slice resource information, the uplink port corresponding to a protocol packet from the data plane and the VLAN information carried by the protocol packet;
in response to the protocol packet being a broadcast or multicast protocol packet, copying the protocol packet, and processing the protocol packet through the network slices listed in the list of network slices.

17. The apparatus according to claim 16, wherein the method further comprises:
in response to the protocol packet being a unicast protocol packet, processing the protocol packet through a network slice to which the VLAN indicated by the VLAN information carried in the protocol packet belongs.

18. The apparatus according to claim 11, wherein the network slice resource information comprises: information of the network slice to which the uplink port belongs, and information of the VLAN used on the shared uplink port by different network slices, information of the VLAN shared by different network slices, and the three-layer interface MAC addresses corresponding to different network slices that share the VLAN on the shared uplink port.
